(19) United States
(12) Patent Application Publication
(10) Pub. No.: US 2017/0254413 A1
(43) Pub. Date: Sep. 7, 2017

(54) SPEED CONTROL SYSTEM FOR STATOR OF TORQUE CONVERTER

(71) Applicant: Caterpillar Inc., Peoria, IL (US)

(72) Inventor: Edward De Jesus Rivera, Peoria, IL (US)

(73) Assignee: Caterpillar Inc., Peoria, IL (US)

(21) Appl. No.: 15/059,328

(22) Filed: Mar. 3, 2016

(51) Int. Cl. F16H 61/56

(52) U.S. Cl. CPC F16H 61/56

(57) ABSTRACT

A speed control system for a stator of a torque converter is provided. The speed control system includes an annular ring member disposed around an outer circumference of the stator. The speed control system further includes a plurality of wing members disposed on an outer circumference of the annular ring member. Each of the plurality of wing members includes a first end and a second end distal to the first end. The speed control system further includes an elastic member disposed at the second end of each of the plurality of wing members. Each of the plurality of wing members is displaced from a first position to a second position against a biasing force of the elastic member, when a rotational speed of the stator is equal to or greater than a threshold speed of the stator, to control the rotational speed of the stator within the threshold speed.

### TECHNICAL FIELD

The present disclosure relates to a torque converter, and more particularly relates to a speed control system for a stator of the torque converter.

### BACKGROUND

Machine with automatic transmission employs a torque converter. The torque converter is a fluid coupling device that typically transfers a rotational torque from a prime mover to a driven load via a transmission. The torque converter typically includes an impeller, a turbine, and a stator. The impeller is connected to a driving shaft of the prime mover, such as a crank shaft of an internal combustion engine. The turbine is connected to an input shaft of the transmission. The stator is located between the turbine and the impeller such that the stator redirects the fluid that exits turbine towards the impeller to further increase the rotational speed of the impeller. A one way stator clutch is utilized to freewheel the stator while transmitting torque between the impeller and the turbine. Further, as the speed of the stator exceeds beyond a desired speed, the one way stator clutch may fail thereby affecting the performance of the torque converter in the machine.

US Patent Publication Number 2009/253823 (the '823 application) discloses a turbine assembly, arranged for disposition in a torque converter. The turbine assembly includes a turbine blade, a turbine shell, and a spring retainer. An attachment means for securing the turbine blade to the turbine shell and the spring retainer, including at least one first blade tab extending outwardly from the turbine blade is arranged to engage at least one first slot within the turbine shell and at least one second slot within the spring retainer. The at least one first blade tab is arranged to fix the at least one blade with respect to the spring retainer. In general, the retainer shell comprises an interior surface and an exterior surface, the exterior surface is arranged to contact the turbine shell, and in some aspects, the at least one first blade tab is arranged to be bent to contact the interior surface. However, the '823 application does not disclose operating conditions causing failure of a one way clutch of the stator.

### SUMMARY OF THE DISCLOSURE

In one aspect of the present disclosure, a speed control system for a stator of a torque converter is provided. The stator is disposed between an impeller and a turbine of the torque converter. The speed control system includes an annular ring member disposed around an outer circumference of the stator. The speed control system further includes a plurality of wing members disposed on an outer circumference of the annular ring member. Each of the plurality of wing members a first end and a second end distal to the first end. The second end is adapted to couple to the annular ring member by a pivot member. Each of the plurality of wing members is movable between a first position and a second position about a pivotal axis defined by the pivot member. The speed control system further includes an elastic member disposed at the second end of each of the plurality of wing members. The first end of each of the plurality of wing members is proximal to the outer circumference of the annular ring member, when each of the plurality of wing members is in the first position. The elastic member is adapted to position each of the plurality of wing members in the first position by a biasing force thereof. Each of the plurality of wing members is displaced from the first position to the second position against the biasing force of the elastic member, when a rotational speed of the stator is equal to or greater than a threshold speed of the stator, to control the rotational speed of the stator within the threshold speed.

In another aspect of the present disclosure, a speed control system for a stator of a torque converter is provided. The stator is disposed between an impeller and a turbine of the torque converter. The speed control system includes an annular ring member disposed on an outer circumference of the stator. The speed control system further includes a plurality of wing members disposed on an outer circumference of the annular ring member. Each of the plurality of wing members a first end coupled to the outer circumference of the annular ring member. Each of the plurality of wing members further includes a second end distal to the first end, and disposed away from the outer circumference of the annular ring member. The first end and the second end define a length with respect to a fluid cavity defined between the impeller and the turbine. Each of the plurality of wing members further includes a first side edge extending between the first end and the second end. Each of the plurality of wing members further includes a second side edge distal to the first side edge, and extending between the first end and the second end. The first side edge and the second side edge define a width with respect to the fluid cavity. Each of the plurality of wing members further includes a planar surface defined between the first end, the second end, the first side edge and the second side edge. The planar surface is at an angle with respect to a tangential surface defined along the outer circumference of the annular ring member. Each of the plurality of wing members controls a rotational speed of the stator within a threshold speed.

Other features and aspects of this disclosure will be apparent from the following description and the accompanying drawings.

### BRIEF DESCRIPTION OF THE DRAWINGS

FIG. 1 is a partial side sectional view of a torque converter having a speed control system disposed on a stator, according to an embodiment of the present disclosure;

FIG. 2 is a perspective view of the stator having the speed control system of FIG. 1;

FIG. 3 is an exploded view of a portion of the speed control system of FIG. 2;

FIG. 4 is a side view of the stator having a speed control system, according to another embodiment of the present disclosure;

FIG. 5 is a side view of the stator showing a first position of a plurality of wing members of the speed control system of FIG. 2; and

FIG. 6 is a side view of the stator showing a second position of the plurality of wing members of the speed control system of FIG. 2.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

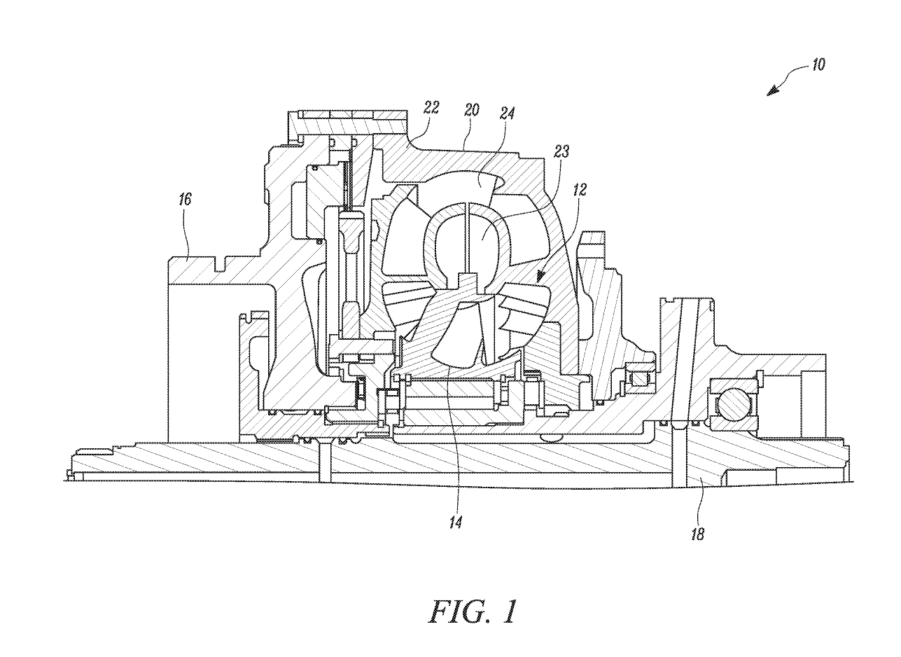

FIG. 1 illustrates a partial side sectional view of a torque converter 10 having a speed control system 12 disposed on a stator 14. The torque converter 10 is a fluid coupling device that transfers a rotational torque from an engine (not shown) to a load, such as ground-engaging elements (not shown) of a machine via a transmission (not shown). In an example, a driving shaft 16 is used to transmit the rotational torque from the engine to the torque converter 10. The torque converter 10 is further rotatably coupled to the transmission through an output shaft 18. The output shaft 18 is used to transmit a power from the torque converter 10 to the load.

The torque converter 10 includes a housing 20 filled with a fluid. The housing 20 is coupled to the driving shaft 16, such that the housing 20 is adapted to be rotated by the driving shaft 16. In an example, the housing 20 of the torque converter 10 may be mounted on a flywheel (not shown) of the engine. The driving shaft 16 may be coupled to the flywheel. The torque converter 10 further includes an impeller 22 and a turbine 24.

The impeller 22 includes array of blades attached to an interior surface of the housing 20 of the torque converter 10. During operation of the engine, the array of blades of the impeller 22 is rotated by the driving shaft 16, and the impeller 22 directs the fluid towards the turbine 24. The turbine 24 also includes array of blades attached to the output shaft 18 of the torque converter 10. During the operation, the fluid pumped by the impeller 22 rotates the turbine 24, and hence transfers the rotational torque from the engine to the transmission. The impeller 22 and the turbine 24 define a fluid cavity 23 therebetween. The fluid cavity 23 is defined to allow flow of the fluid between the impeller 22 and the turbine 24 so as to transfer mechanical power from the impeller 22 to the turbine 24. The fluid entering the impeller 22 from the housing 20 passes through the fluid cavity 23 towards the turbine 24.

The stator 14 is disposed between the impeller 22 and the turbine 24 such that the stator 14 redirects the fluid exiting from the turbine 24 towards the impeller 22 to regulate a rotational speed of the impeller 22. The stator 14 also includes an array of blades adapted to control a direction of fluid flow that is exiting from the turbine 24 to align with a direction of the fluid flow with respect to the impeller 22. During an idle condition of the engine, i.e., the fluid exiting from the turbine 24 impinges on the array of blades of the stator 14 in such a way that, the stator 14 may tend to rotate in an opposite direction with respect to the fluid flow.

However, the stator 14 is prevented from rotating in the opposite direction with respect to the fluid flow due to presence of a one way clutch 25. The one way clutch 25 is provided between the stator 14 and the output shaft 18, and adapted to prevent rotation of the stator 14 in the opposite direction. During the operation of the engine, the speed at which the turbine 24 rotates is equal to the speed at which the impeller 22 rotates. During such operating condition, the stator 14 starts to spin and as soon as the stator 14 starts to spin, the stator 14 freewheels at the same speed as the turbine 24 and the impeller 22.

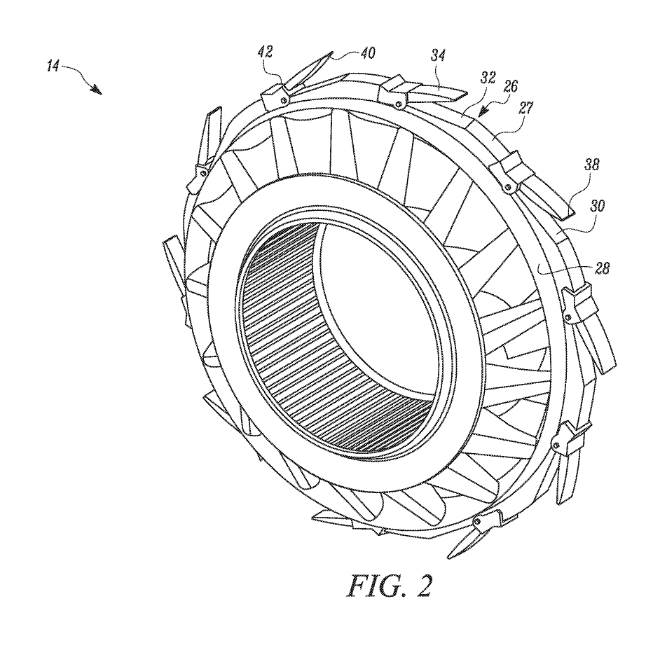

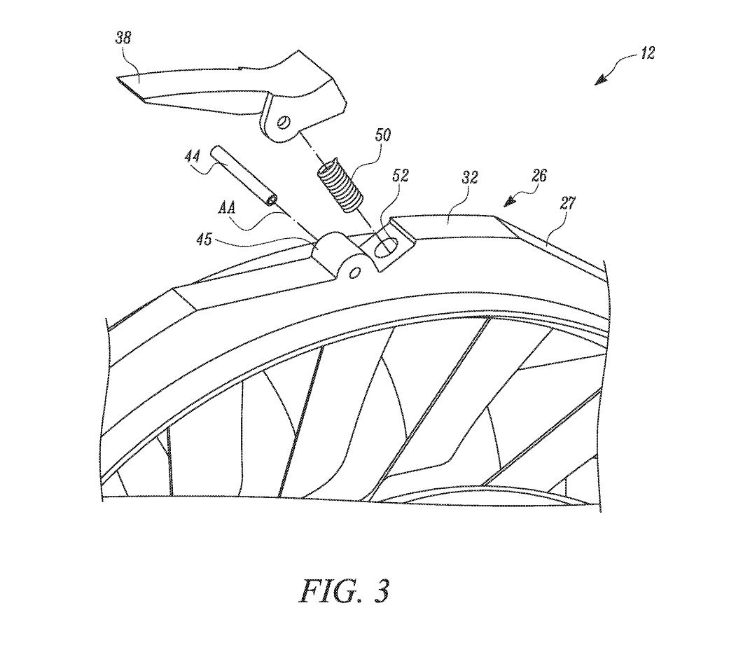

FIG. 2 illustrates a perspective view of the stator 14 having the speed control system 12 of FIG. 1. The speed control system 12 includes an annular ring member 26 disposed around an outer circumference 28 of the stator 14. The annular ring member 26 includes a plurality of recessed portions 30. Each of the plurality of recessed portions 30 includes a first mating surface 32 (shown in FIG. 3). The first mating surface 32 is at an angle with respect to the outer circumference 28 of the stator 14. Although, the plurality of recessed portions 30 is shown and described with reference to FIG. 2, it may be contemplated that the stator 14 may be provided with a single recessed portion.

The speed control system 12 further includes a plurality of wing members 34 disposed at the plurality of recessed portions 30 of the annular ring member 26. In an example, the plurality of wing members 34 may be mounted along the outer circumference 28 of the stator 14 to control speed of the stator 14. Each of the plurality of wing members 34 includes a first end 38 having a second mating surface 40 (shown in FIG. 3). The second mating surface 40 of each of the plurality of wing members 34 is adapted to conform to the first mating surface 32 of each of the plurality of recessed portions 30. In an example, profile of an outer surface of each of the plurality of wing members 34 may be defined in such a way to have a continuous surface along an outer circumference 27 of the annular ring member 26. Thus, assembly of the annular ring member 26 and the plurality of wing members 34 on the stator 14 form a circular profile.

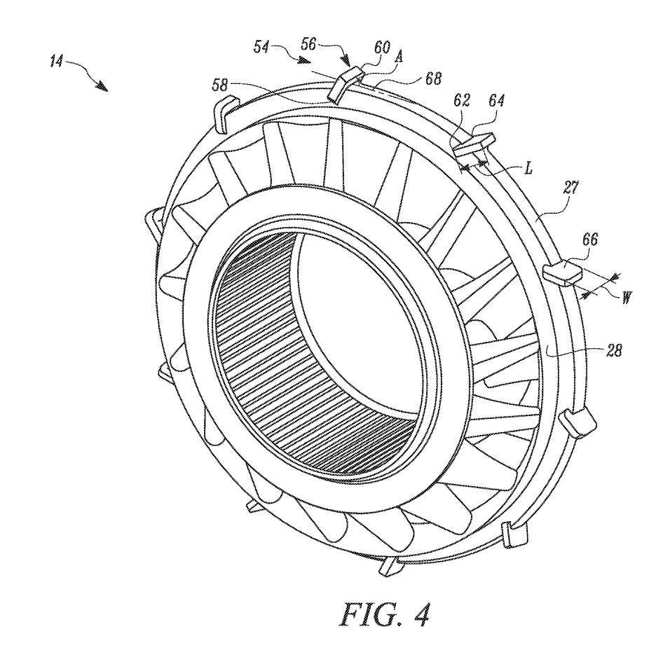

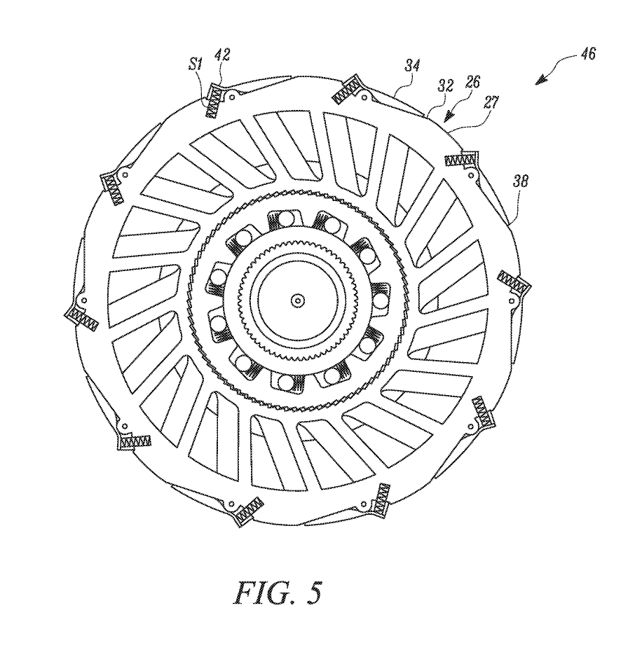

Each of the plurality of wing members 34 further includes a second end 42 distal to the first end 38. The second end 42 is coupled to the annular ring member 26 by a pivot member 44. Further, the second end 42 of each of the plurality of wing members 34 is proximal to the outer circumference 27 of the annular ring member 26. Although, the plurality of wing members 34 is shown and described with reference to FIG. 2, it may be understood that the stator 14 may be provided with a single wing member. Owing to the presence of the pivot member 44, each of the plurality of wing members 34 is movable between a first position 46 (shown in FIG. 4) and a second position 48 (shown in FIG. 5) about a pivotal axis ‘AA’ defined by the pivot member 44. In an example, the pivot member 44 may be a pin.

FIG. 3 illustrates an exploded view of a portion of the stator 14 having the speed control system 12. One wing member 34 is shown in FIG. 3 for illustration purpose of the present disclosure. The speed control system 12 further includes a protrusion 45 extending from the first mating surface 32. As shown in FIG. 3, the protrusion 45 is provided in a semi-circular cross section and includes a through-hole 47 to receive the pivot member 44 therein for holding the wing member 34.

The speed control system 12 further includes an elastic member 50 disposed at the second end 42 of each of the plurality of wing members 34. In an example, the elastic member 50 may be, but not limited to, a spring disposed at the second end 42 of each of the plurality of wing members 34. The elastic member 50 is adapted to position each of the plurality of wing members 34 in the first position 46 by a biasing force thereof.

The elastic member 50 is at an expanded condition ‘S1’ (shown in FIG. 4) when the plurality of wing members 34 is at the first position 46 and the elastic member 50 is at a compressed condition ‘S2’ (shown in FIG. 5) when the plurality of wing members 34 is at the second position 48. The plurality of wing members 34 of the stator 14 moves from the first position 46 to the second position 48 to oppose the fluid flow created between the impeller 22 and the turbine 24, thereby preventing the stator 14 from rotating at a speed equal to or greater than a threshold speed of the stator 14. Actuation of the plurality of wing members 34 to the second position 48 will be described in detail with reference to FIG. 5. The threshold speed may be defined as a maximum speed capability of the one way clutch 25, beyond which performance of the torque converter 10 may degrade. The threshold speed may be defined based on various operating parameters including, but not limited to, the fluid flow within the housing 20 of the torque converter 10, torque requirement, and various other parameters of the one way clutch 25. It is to be understood that the elastic member 50 and the plurality of wing members 34 are designed based on the threshold speed to be maintained within the torque converter 10 during operation of the torque converter 10. Further, the elasticity and various other dimensional characteristics of the elastic member 50 may be determined based on the various operating parameters, such as the fluid flow, speed of the driving shaft 16 and fluid characteristics, such as viscosity.

In the illustrated embodiment, the elastic member 50 is received within an aperture 52 provided in the annular ring member 26 of the stator 14. In the case of spring, a depth of the aperture 52 may be defined based on the free length, stiffness, the expanded condition ‘S1’ and the compressed condition ‘S2’ of the spring. The aperture 52 may be a notch in the plurality of recessed portions 30 to receive the elastic member 50.

In an alternate embodiment, the elastic member 50 may be replaced with a torsional spring disposed at the second end 42 of each of the plurality of wing members 34. The torsional spring may be disposed around the pivot member 44 to cause movement of the plurality of wing members 34 between the first position 46 and the second position 48 based on the rotational speed of the stator 14. The torsional spring may be designed based on the threshold speed of the stator 14 to be maintained within the torque converter 10.

FIG. 4 is a side view of the stator 14 having a speed control system 54, according to another embodiment of the present disclosure. The speed control system 54 includes the annular ring member 26 disposed around the outer circumference 28 of the stator 14. The speed control system 54 further includes a plurality of wing members 56 disposed on the outer circumference 27 of the annular ring member 26. The plurality of wing members 56 is disposed along the outer circumference 28 of the stator 14 to control the rotational speed of the stator 14.

Each of the plurality of wing members 56 includes a first end 58 coupled to the outer circumference 27 of the annular ring member 26. Each of the plurality of wing members 56 further includes a second end 60 that is distal to the first end 58. The second end 60 is disposed away from the outer circumference 27 of the annular ring member 26. As shown in FIG. 4, each of the plurality of wing members 56 is an integral component of the stator 14. In an example, each of the plurality of wing members 56 may be welded to the annular ring member 26. In another example, each of the plurality of wing members 56 may be fastened to the annular ring member 26 by a fastening member, such as a bolt. Although FIG. 4 shows the plurality of wing members 56, it may be understood that the stator 14 is provided with a single wing member.

The first end 58 and the second end 60 define a length “L” with respect to the fluid cavity 23 defined between the impeller 22 and the turbine 24. Each of the plurality of wing members 56 further includes a first side edge 62 extending between the first end 58 and the second end 60. Each of the plurality of wing members 56 further includes a second side edge 64 that is distal to the first side edge 62. The second side edge 64 extends between the first end 58 and the second end 60. The first side edge 62 and the second side edge 64 define a width “W” with respect to the fluid cavity 23.

Each of the plurality of wing members 56 further includes a planar surface 66 defined between the first end 58, the second end 60, the first side edge 62, and the second side edge 64. The planar surface 66 is at an angle “A” with respect to a tangential surface 68 defined along the outer circumference 27 of the annular ring member 26. Each of the plurality of wing members 56 extends outwardly from a point defined along the outer circumference 27 of the annular ring member 26. The point from which each of the plurality of wing members 56 extend may, for the purpose of description, be considered as “Point of emergence”. A tangent passing through the “Point of emergence” may define the tangential surface 68 with respect to the outer circumference 27 of the annular ring member 26.

In operation, when the rotational speed of the stator 14 is equal to or greater than the threshold speed of the stator 14 the plurality of wing members 56 is exposed to a reaction force caused by the fluid flow between the impeller 22 and the turbine 24 within the torque converter 10. Hence, the stator 14 experiences a resistance by the fluid flow due to various dimensional specifications including, but not limited to, the length “L” and the width “W” of the plurality of wing members 56 inside the housing 20. Thus, the speed control system 54 controls the rotational speed of the stator 14 within the threshold speed or maintain the threshold speed during operation of the torque converter 10.

### INDUSTRIAL APPLICABILITY

The present disclosure relates to the speed control system 12 for the stator 14 of the torque converter 10 for controlling the rotational speed of the stator 14. The speed control system 12 prevents failure of the one way clutch 25 as the plurality of wing members 34 controls the rotational speed of the stator 14 within the threshold speed. The speed control system 12 improves performance of the torque converter 10 of the machine by controlling the rotational speed of the stator 14.

FIG. 5 illustrates a side view of the stator 14 showing the first position 46 of the plurality of wing members 34 of FIG. 2. The first position 46 referred herein is a position of the plurality of wing members 34 at which the second mating surface 40 thereof abuts the first mating surface 32 of each of the plurality of recessed portions 30 when the rotational speed of the stator 14 is within the threshold speed. In the first position 46 of the plurality of wing members 34, each of the elastic members 50 are at the expanded position ‘S1’ and hence position each of the plurality of wing members 34 in the first position 46 by the biasing force thereof. The second mating surface 40 of the plurality of recessed portions 30 abuts the first mating surface 32 of the plurality of recessed portions 30, by the biasing force of the elastic members 50. The plurality of wing members 34 remains to be in the first position 46 as long as the speed of the stator 14 is within the threshold speed. Thus, the flow of fluid experiences a minimum resistance or zero resistance by the plurality of wing members 34 inside the housing 20.

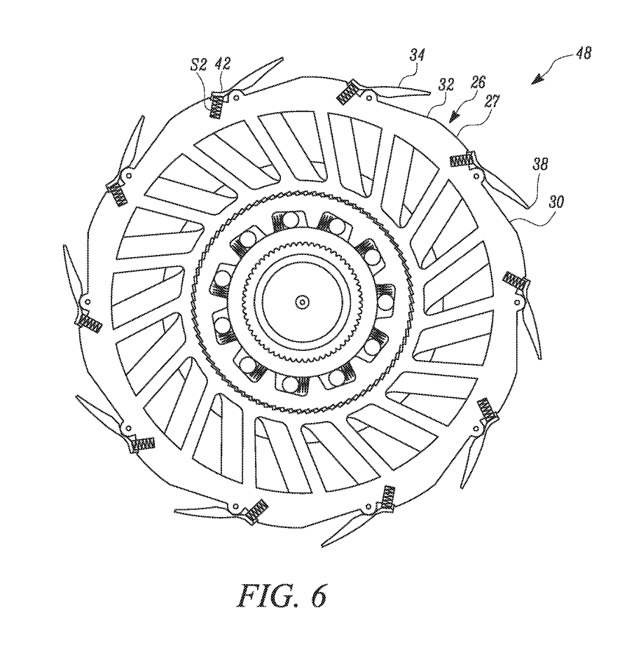

FIG. 6 illustrates a side view of the stator 14 showing the second position 48 of the plurality of wing members 34 of FIG. 2. When the rotational speed of the stator 14 is equal to or greater than the threshold speed of the stator 14, by virtue of centripetal force developed due to the rotational speed, the plurality of wing members 34 are displaced from the first position 46 to the second position 48 by overcoming the biasing force of the plurality of elastic members 50. As the plurality of elastic members 50 located below the plurality of the wing members 34 moves to the compressed condition ‘S2’, the plurality of wing members 34 moves to the second position 48.

Since the plurality of wing members 34 is disposed distal with respect to the first mating surface 32 in the second position 48, the plurality of wing members 34 are exposed to a reaction force caused by the fluid flow between the impeller 22 and the turbine 24 within the torque converter 10. Hence, the stator 14 experiences a resistance by the fluid flow due to the movement of the plurality of wing members 34 to the second position 48 inside the housing 20. Thus, the speed control system 12 controls the rotational speed of the stator 14 within the threshold speed or maintain the threshold speed during operation of the torque converter 10.

The semi-circular cross section of the protrusion 45 facilitates smoother or free movement of the plurality of wing members 34 about the pivot axis ‘AA’. With reference to the alternate embodiment, the plurality of wing members provided on the annular ring member 26 of the stator 14 may oppose the fluid flow created between the impeller 22 and the turbine 24, thereby preventing the stator 14 from rotating at a speed equal to or greater than the threshold speed of the stator 14. The plurality of wing members 34 and 56 according to the various embodiments of the present disclosure control the rotational speed of the stator 14 within the threshold speed during operation of the torque converter 10.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A speed control system for a stator of a torque converter, the stator disposed between an impeller and a turbine of the torque converter, the speed control system comprising:
an annular ring member disposed around an outer circumference of the stator;
a plurality of wing members disposed on an outer circumference of the annular ring member, wherein each of the plurality of wing members includes:
a first end;
a second end distal to the first end, the second end adapted to couple to the annular ring member by a pivot member, wherein each of the plurality of wing members is movable between a first position and a second position about a pivotal axis defined by the pivot member; and
an elastic member disposed at the second end of each of the plurality of wing members, wherein the second end of each of the plurality of wing members is proximal to the outer circumference of the annular ring member, when each of the plurality of wing members is in the first position, wherein the elastic member is adapted to position each of the plurality of wing members in the first position by a biasing force thereof,
wherein each of the plurality of wing members is displaced from the first position to the second position against the biasing force of the elastic member, when a rotational speed of the stator is equal to or greater than a threshold speed of the stator, to control the rotational speed of the stator within the threshold speed.

2. A speed control system for a stator of a torque converter, the stator disposed between an impeller and a turbine of the torque converter, the speed control system comprising:
an annular ring member disposed on an outer circumference of the stator; and
a plurality of wing members disposed on an outer circumference of the annular ring member, wherein each of the plurality of wing members includes:
a first end coupled to the outer circumference of the annular ring member;
a second end distal to the first end, and disposed away from the outer circumference of the annular ring member, wherein the first end and the second end define a length with respect to a fluid cavity defined between the impeller and the turbine;
a first side edge extending between the first end and the second end;
a second side edge distal to the first side edge, and extending between the first end and the second end, wherein the first side edge and the second side edge define a width with respect to the fluid cavity; and
a planar surface defined between the first end, the second end, the first side edge and the second side edge, wherein the planar surface is at an angle with respect to a tangential surface defined along the outer circumference of the annular ring member,
wherein each of the plurality of wing members controls a rotational speed of the stator within a threshold speed.
